(19) United States
(12) Patent Application Publication
(10) Pub. No.: US 2006/0261314 A1
(43) Pub. Date: Nov. 23, 2006

(54) Hole transport composition

(76) Inventors: Charles D. Lang, Goleta, CA (US); Che-Hsiung Hsu, Wilmington, DE (US); Ian D. Parker, Santa Barbara, CA (US)

Correspondence Address: Mary Ann Capria;E I Du Pont De Nemours and Company, Legal Patent Records Center, 4417 Lancaster Pike, Wilmington, DE, 19805, US

(21) Appl. No.: 10/555,284

(22) PCT Filed: May 19, 2004
(86) PCT No.: PCT/US04/16409

§ 371 Date: Nov. 2, 2005

Related U.S. Application Data
(60) Provisional application No. 60/471,797, filed on May 19, 2003.

(51) Int. Cl. H01B 1/12

(52) U.S. Cl. 252/500

(57) ABSTRACT

The invention relates to aqueous compositions comprising at least one doped conductive polymer, at least one co-solvent, and at least one metal cation selected from Group 1 metals or Group 2 metals or mixtures thereof.

### FIELD OF THE INVENTION

The invention relates to an aqueous hole transport composition, and to devices comprising buffer layers including such compositions.

### BACKGROUND OF THE INVENTION

Electrically conducting polymers have been used in a variety of organic electronic devices, including in the development of electroluminescent (“EL”) devices for use in light emissive displays. With respect to EL devices, such as organic light emitting diodes (OLEDs) containing conducting polymers, such devices generally have the following configuration:
anode/buffer layer/EL material/cathode
   The anode is typically any material that is transparent and has the ability to inject holes into the EL material, such as, for example, indium/tin oxide (ITO). The anode is optionally supported on a glass or plastic substrate. EL materials include fluorescent dyes, fluorescent and phosphorescent metal complexes, conjugated polymers, and mixtures thereof. The cathode is typically any material (such as, e.g., Ca or Ba) that has the ability to inject electrons into the EL material.

The buffer layer typically includes an electrically conducting polymer and facilitates the injection of holes from the anode into the EL material layer. Typical conducting polymers employed as buffer layers include polyaniline (“PAni”) and polydioxythiophenes such as poly(3,4-ethylenedioxythiophene) (“PEDT”). These materials can be prepared by polymerizing aniline or dioxythiophene monomers in aqueous solution in the presence of a water soluble polymeric acid, such as poly(styrenesulfonic acid) (PSSA), or poly(2-acrylamido-2-methyl-1-propanesulfonic acid) (“PAAMPSA”), as described in, for example, U.S. Pat. No. 5,300,575 and published PCT application WO 02/065484. A well known PEDT/PSS material is Baytron®-P, commercially available from H. C. Starck, GmbH (Leverkusen, Germany).

There is a need for improved conductive polymer layers for electronic devices.

### SUMMARY OF THE INVENTION

New aqueous compositions are provided comprising at least one doped conductive polymer, at least one co-solvent, and at least one metal cation selected from Group 1 metals or Group 2 metals or mixtures thereof.

In another embodiment, electronic devices comprising a buffer layer comprises the new composition.

The foregoing general description and the following detailed description are exemplary and explanatory only and are not restrictive of the invention, as defined in the appended claims.

### BRIEF DESCRIPTION OF THE FIGURES

The invention is illustrated by way of example and not limited in the accompanying figures.

FIG. 1 illustrates a cross-sectional view of an electronic device that comprises a buffer layer comprises the new composition.

### DETAILED DESCRIPTION OF THE INVENTION

In one embodiment, aqueous compositions are provided comprising at least one doped conductive polymer, at least one co-solvent, and at least one metal cation selected from Group 1 metals or Group 2 metals, and mixtures thereof.

As used herein, the term “aqueous” refers to a liquid that has a significant portion of water, and in one embodiment it is at least about 40% by weight water. The term “doped” refers to the formation of an ion pair wherein the negative charge on an anion balances the positive charge on a conductive polymer. The anion is referred to as a “dopant”. The term “co-solvent” refers to an organic substance which is liquid at room temperature and is miscible with water. The term “miscible” means that the co-solvent is capable of being mixed with water (at the concentration used) to form a substantially homogeneous solution. The IUPAC number system is used throughout, where the groups from the Periodic Table are numbered from left to right as 1-18 (CRC Handbook of Chemistry and Physics, 81^{st} Edition, 2000).

The conductive polymers suitable for the new composition can be homopolymers, or they can be co-polymers of two or more respective monomers. The composition may further comprise one or more different conductive polymers. In one embodiment, the conductive polymer is selected from polythiophenes, or polypyrroles, or polyanilines, or combinations thereof.

Polythiophenes contemplated for use in the new composition comprise Formula I below:

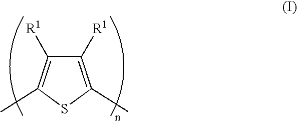

wherein:
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, amidosulfonate, ether carboxylate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms, and
n is at least about 4.

As used herein, the term “alkyl” refers to a group derived from an aliphatic hydrocarbon and includes linear, branched and cyclic groups which may be unsubstituted or substituted. The term “heteroalkyl” is intended to mean an alkyl group, wherein one or more of the carbon atoms within the alkyl group has been replaced by another atom, such as nitrogen, oxygen, sulfur, and the like. The term “alkylene” refers to an alkyl group having two points of attachment.

As used herein, the term “alkenyl” refers to a group derived from an aliphatic hydrocarbon having at least one carbon-carbon double bond, and includes linear, branched and cyclic groups which may be unsubstituted or substituted. The term “heteroalkenyl” is intended to mean an alkenyl group, wherein one or more of the carbon atoms within the alkenyl group has been replaced by another atom, such as nitrogen, oxygen, sulfur, and the like. The term “alkenylene” refers to an alkenyl group having two points of attachment.

As used herein, the following terms for substituent groups refer to the formulae given below:
“alcohol” —R³—OH
“amidosulfonate” —R³—C(O)N(R⁶) R⁴—SO₃Z
“benzyl” —CH₂—C₆H₅
“carboxylate” —R³—C(O)O-Z
“ether” —R³—O—R⁵
“ether carboxylate” —R³—O—R⁴—C(O)O-Z
“ether sulfonate” —R³—O—R⁴—SO₃Z
“urethane” —R³—O—C(O)—N(R⁶)₂
where all “R” groups are the same or different at each occurrence and:
   R³ is a single bond or an alkylene group
   R⁴ is an alkylene group
   R⁵ is an alkyl group
   R⁶ is hydrogen or an alkyl group
   Z is H, alkali metal, alkaline earth metal, N(R⁵)₄ or R⁵
   Any of the above groups may further be unsubstituted or substituted, and any group may have fluorine substituted for one or more hydrogens, including perfluorinated groups.

In one embodiment, in the polythiophene both R¹ together form —O—(CHY)ₘ—O—, where m is 2 or 3, and Y is the same or different at each occurrence and is selected from hydrogen, alkyl, alcohol, amidosulfonate, benzyl, carboxylate, ether, ether carboxylate, amidosulfonate, ether sulfonate, and urethane. In one embodiment, all Y are hydrogen. In one embodiment, the polythiophene is poly(3,4-ethylenedioxythiophene). In one embodiment, at least one Y group is not hydrogen. In one embodiment, at least one Y group is a substituent having fluorine substituted for at least one hydrogen. In one embodiment, at least one Y group is perfluorinated.

Polypyrroles contemplated for use the new composition comprise Formula II below. 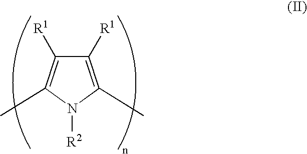
where in Formula II:
n is at least about 4;
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, amidosulfonate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms; and
R² is independently selected so as to be the same or different at each occurrence and is selected from hydrogen, alkyl, alkenyl, aryl, alkanoyl, alkylthioalkyl, alkylaryl, arylalkyl, amino, epoxy, silane, siloxane, alcohol, benzyl, carboxylate, ether, amidosulfonate, ether carboxylate, ether sulfonate, and urethane.

In one embodiment, R¹ is the same or different at each occurrence and is independently selected from hydrogen, alkyl, alkenyl, alkoxy, cycloalkyl, cycloalkenyl, alcohol, benzyl, carboxylate, ether, amidosulfonate, ether carboxylate, ether sulfonate, urethane, epoxy, silane, siloxane, and alkyl substituted with one or more of sulfonic acid, carboxylic acid, acrylic acid, phosphoric acid, phosphonic acid, halogen, nitro, cyano, hydroxyl, epoxy, silane, or siloxane moieties.

In one embodiment, R² is selected from hydrogen, alkyl, and alkyl substituted with one or more of sulfonic acid, carboxylic acid, acrylic acid, phosphoric acid, phosphonic acid, halogen, cyano, hydroxyl, epoxy, silane, or siloxane moieties.

In one embodiment, the polypyrrole is unsubstituted and both R¹ and R² are hydrogen.

In one embodiment, both R¹ together form a 6- or 7-membered alicyclic ring, which is further substituted with a group selected from alkyl, heteroalkyl, alcohol, benzyl, carboxylate, ether, ether carboxylate, amidosulfonate, ether sulfonate, and urethane. These groups can improve the solubility of the monomer and the resulting polymer. In one embodiment, both R¹ together form a 6- or 7-membered alicyclic ring, which is further substituted with an alkyl group. In one embodiment, both R¹ together form a 6- or 7-membered alicyclic ring, which is further substituted with an alkyl group having at least 1 carbon atom.

In one embodiment, both R¹ together form —O—(CHY)ₘ—O—, where m is 2 or 3, and Y is the same or different at each occurrence and is selected from hydrogen, alkyl, alcohol, benzyl, carboxylate, ether, ether carboxylate, amidosulfonate, ether sulfonate, and urethane. In one embodiment, at least one Y group is not hydrogen. In one embodiment, at least one Y group is a substituent having fluorine substituted for at least one hydrogen. In one embodiment, at least one Y group is perfluorinated.

Polyanilines contemplated for use in the new composition comprise Formula III or Formula IV below.

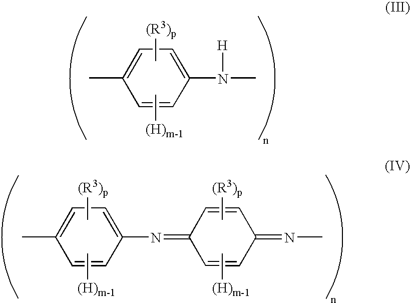

wherein:
n is at least about 4;
p is an integer from 0 to 4;
m is an integer from 1 to 5, with the proviso that p+m=5; and
R³ is independently selected so as to be the same or different at each occurrence and is selected from alkyl, alkenyl, alkoxy, cycloalkyl, cycloalkenyl, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen, cyano, or alkyl substituted with one or more of sulfonic acid, carboxylic acid, halo, nitro, cyano or epoxy moieties; or any two R³ groups together may form an alkylene or alkenylene chain completing a 3, 4, 5, 6, or 7-membered aromatic or alicyclic ring, which ring may optionally include one or more divalent nitrogen, sulfur or oxygen atoms.

In one embodiment, the polyaniline is unsubstituted and p=0.

The synthesis of thiophene, pyrrole, and aniline polymers is well known and has been extensively described. Polymerization of thiophene monomers has been described in, for example, U.S. Pat. No. 5,300,575. Polymerization of aniline monomers has been described in, for example, U.S. Pat. No. 5,798,170.

In one embodiment, the conductive polymer is made by oxidative polymerization of the monomer or monomers to form the conductive polymer, in the presence of a soluble acid. The acid can be a polymeric or non-polymeric acid. The polymerization is generally carried out in a homogeneous solution. In one embodiment, the polymerization is carried out in a homogeneous aqueous solution. In another embodiment, the polymerization for obtaining the electrically conducting polymer is carried out in an emulsion of water and an organic solvent. In general, some water is present in order to obtain adequate solubility of the oxidizing agent and/or catalyst. Oxidizing agents such as ammonium persulfate, sodium persulfate, potassium persulfate, and the like, can be used. A catalyst, such as ferric chloride, or ferric sulfate may also be present. The resulting polymerized product will be a solution, dispersion, or emulsion of the doped conductive polymer. Aqueous dispersions of polypyrrole and a non-polymeric organic acid anion are available commercially from Sigma-Aldrich (St. Louis, Mo.). Aqueous dispersions of poly(2,3-ethylendioxythiophene)/PSSA are available commercially from H.C. Starck, GmbH. (Leverkusen, Germany). Aqueous dispersions of doped polyaniline are available commercially from Covion Organic Semiconductors GmbH (Frankfurt, Germany) or Ormecon (Ambersbek, Germany).

The polythiophene and polypyrrole polymers formed by oxidative polymerization are positively charged. In the conductive form of polyaniline at least some of the nitrogens are protonated, so that it also is positively charged. The positive charges are balanced by the negative charge of the dopant. In one embodiment the dopant is an organic anion. In one embodiment, the dopant is an organic acid anion. The organic acid can be polymeric or non-polymeric. The acids are selected to be soluble in the polymerization medium for the conductive polymer, and accordingly, can be water-soluble or organic solvent soluble. The acid anions can be selected from sulfonates, carboxylates, phosphates, phosphonates, acrylates, and mixtures thereof. In one embodiment, the acid is a sulfonic acid. In one embodiment, the acid is a water-soluble acid or organic-soluble acid selected from a non-polymeric organic acid, a water soluble polymeric acid, and combinations thereof.

Examples of polymeric organic acids include, but are not limited to, poly(styrenesulfonic acid) (PSSA), and poly(2-acrylamido-2-methyl-1-propanesulfonic acid) (“PAAMPSA”). The corresponding acid anions are the sulfonates, “PSS” and “PAAMPS”. Examples of suitable non-polymeric acids include, but are not limited to, acetic acid, p-toluenesulfonic acid, camphorsulfonic acid, p-dodecylbenzenesulfonic acid, methanesulfonic acid, trifluoromethanesulfonic acid, and the like. The corresponding acid anions are acetate, p-toluenesulfonate, camphorsulfonate, p-dodecylbenzenesulfonate, methanesulfonate, and trifluoromethanesulfonate. Mixtures of acid anions can be used.

The combination of the positively charged conductive polymer and the anion is referred to as the “doped conductive polymer.”

Aqueous dispersions of electrically conducting polymers, which typically have a high surface energy of 73 mili-newton/meter, frequently form thin layers with coating inhomogeneity when spin-coated on an indium/tin oxide surface. For example, films made from Baytron-P CH8000 or Al4083, which are aqueous dispersions of electrically conductive poly(3,4-ethylendioxythiophene)/PSSA available commercially from H.C. Starck, GmbH. (Leverkusen, Germany), are known to have coating defects, such as streaks, speed boats, mottles and/or bubbles. The new aqueous compositions of the invention form films having improved coating homogeneity.

Co-solvents contemplated for use in the new composition are generally polar, water-miscible organic liquids. Examples of suitable types of co-solvents include, but are not limited to, ethers, cyclic ethers, alcohols, alcohol ethers, ketones, nitriles, sulfides, sulfoxides, amides, amines, carboxylic acids, as well as combinations of any two or more thereof.

Exemplary ether co-solvents contemplated for use in the new composition include, but are not limited to, diethyl ether, ethyl propyl ether, dipropyl ether, diisopropyl ether, dibutyl ether, methyl t-butyl ether, glyme, diglyme, benzyl methyl ether, isochroman, 2-phenylethyl methyl ether, n-butyl ethyl ether, 1,2-diethoxyethane, sec-butyl ether, diisobutyl ether, ethyl n-propyl ether, ethyl isopropyl ether, n-hexyl methyl ether, n-butyl methyl ether, methyl n-propyl ether, and the like, as well as combinations of any two or more thereof.

Exemplary cyclic ether co-solvents contemplated for use in the new composition include, but are not limited to, 1,4-dioxane, tetrahydrofuran, tetrahydropyran, 4 methyl-1,3-dioxane, 4-phenyl-1,3-dioxane, 1,3-dioxolane, 2-methyl-1,3-dioxolane, 1,3-dioxane, 2,5-dimethoxytetrahydrofuran, 2,5-dimethoxy-2,5-dihydrofuran, and the like, as well as combinations of any two or more thereof. In one embodiment, the cyclic ether co-solvent is tetrahydrofuran, tetrahydropyran, or 1,4-dioxane.

Exemplary alcohol co-solvents contemplated for use in the new composition include, but are not limited to, methanol, ethanol, 1-propanol, 2-propanol (i.e., isopropanol), 1-butanol, 2-butanol, 2-methyl-1-propanol (i.e., isobutanol), 2-methyl-2-propanol (i.e., tert-butanol), 1-pentanol, 2-pentanol, 3-pentanol, 2,2-dimethyl-1-propanol, 1-hexanol, cyclopentanol, 3-methyl-1-butanol, 3-methyl-2-butanol, 2-methyl-1-butanol, 2,2-dimethyl-1-propanol, 3-hexanol, 2-hexanol, 4-methyl-2-pentanol, 2-methyl-1-pentanol, 2-ethylbutanol, 2,4-dimethyl-3-pentanol, 3-heptanol, 4-heptanol, 2-heptanol, 1-heptanol, 2-ethyl-1-hexanol, 2,6-dimethyl-4-heptanol, 2-methylcyclohexanol, 3-methylcyclohexanol, 4-methylcyclohexanol, and the like, as well as combinations of any two or more thereof. In one embodiment, the alcohol co-solvent is methanol, ethanol, or isopropanol.

Exemplary alcohol ether co-solvents contemplated for use in the new composition include, but are not limited to, 2-butoxyethanol, 1-methoxy-2-propanol, 2-methoxyethanol, 2-ethoxyethanol, 1-methoxy-2-butanol, ethylene glycol monoisopropyl ether, 1-ethoxy-2-propanol, 3-methoxy-1-butanol, ethylene glycol monoisobutyl ether, ethylene glycol mono-n-butyl ether, 3-methoxy-3-methylbutanol, ethylene glycol mono-tert-butyl ether, and the like, as well as combinations of any two or more thereof. In one embodiment, the alcohol ether co-solvent is 1-methoxy-2-propanol, 2-methoxyethanol, or 2-butoxyethanol.

Exemplary ketone co-solvents contemplated for use in the new composition include, but are not limited to, acetone, methylethyl ketone, methyl iso-butyl ketone, cyclohexanone, isopropyl methyl ketone, 2-pentanone, 3-pentanone, 3-hexanone, diisopropyl ketone, 2-hexanone, cyclopentanone, 4-heptanone, iso-amyl methyl ketone, 3-heptanone, 2-heptanone, 4-methoxy-4-methyl-2-pentanone, 5-methyl-3-heptanone, 2-methylcyclohexanone, diisobutyl ketone, 5-methyl-2-octanone, 3-methylcyclohexanone, 2-cyclohexen-1-one, 4-methylcyclohexanone, cycloheptanone, 4-tert-butylcyclohexanone, isophorone, benzyl acetone, and the like, as well as combinations of any two or more thereof.

Exemplary nitrile co-solvents contemplated for use in the new composition include, but are not limited to, acetonitrile, acrylonitrile, trichloroacetonitrile, propionitrile, pivalonitrile, isobutyronitrile, n-butyronitrile, methoxyacetonitrile, 2-methylbutyronitrile, isovaleronitrile, n-valeronitrile, n-capronitrile, 3-methoxypropionitrile, 3-ethoxypropionitrile, 3,3′-oxydipropionitrile, n-heptanenitrile, glycolonitrile, benzonitrile, ethylene cyanohydrin, succinonitrile, acetone cyanohydrin, 3-n-butoxypropionitrile, and the like, as well as combinations of any two or more thereof.

Exemplary sulfoxide co-solvents contemplated for use in the new composition include, but are not limited to, dimethyl sulfoxide (DMSO), di-n-butyl sulfoxide, tetramethylene sulfoxide, methyl phenyl sulfoxide, and the like, as well as combinations of any two or more thereof.

Exemplary amide co-solvents contemplated for use in the new composition include, but are not limited to, dimethyl formamide (DMF), dimethyl acetamide, acylamide, 2-acetamidoethanol, N,N-dimethyl-m-toluamide, trifluoroacetamide, N,N-dimethylacetamide, N,N-diethyldodecanamide, ε-caprolactam, N,N-diethylacetamide, N-tert-butylformamide, formamide, pivalamide, N-butyramide, N,N-dimethylacetoacetamide, N-methyl formamide, N,N-diethylformamide, N-formylethylamine, acetamide, N,N-diisopropylformamide, 1-formylpiperidine, N-methylformanilide, and the like, as well as combinations of any two or more thereof.

Exemplary amine co-solvents contemplated for use in the new composition include, but are not limited to, mono-, di-, and tri-alkyl amines, cyclic amines (such as, e.g., pyrrolidine), aromatic amines (such as, e.g., pyridine) and the like, as well as combinations of any two or more thereof. In one embodiment, the amine co-solvent is pyridine.

Exemplary carboxylic acid co-solvents contemplated for use in the new composition include, but are not limited to, C₁ up to about C₆ straight or branched chain carboxylic acids, as well as combinations of any two or more thereof. In one embodiment, the carboxylic acid co-solvent is formic acid.

In one embodiment, the co-solvent is selected from an alcohol, an alcohol ether, and combinations thereof. In one embodiment, the co-solvent is selected from normal propyl alcohol, 1-methoxy-2-propanol, and combinations thereof.

In one embodiment, the co-solvent is present in an amount from about 5% by weight to about 60% by weight, based on the total weight of liquid. In one embodiment, the co-solvent is present in an amount of from about 10% by weight to about 30% by weight.

The metal cations contemplated for use in the new composition are present in the form of water soluble salts. Suitable anions include, but are not limited to, halide, carbonate, bicarbonate, sulfate, nitrate, acetate, tetrafluoroborate, and hexafluorophosphate. Combinations of salts can be used. Metal hydroxides can be used, however the resulting increase in pH may adversely affect the properties of the conductive polymer at higher concentrations. For example, aqueous poly(ethylenedioxythiophene) (“PEDT”) dispersions for OLED applications, Baytron®-P VP Al 4083 and CH8000, from H. C. Starck, GmbH, Leverkusen, Germany, have a pH below 2. With Baytron-P®, adjusting the pH to higher levels can have a deleterious effect on the electrical properties of the conductive polymer and their functional effectiveness as a buffer layer in OLEDs. In one embodiment, a pH well above 2 must be avoided when the metal cation is added as an aqueous basic solution, such as aqueous sodium hydroxide solution.

In one embodiment, the metal cation is selected from Na⁺, K⁺, Cs⁺ Mg⁺², and combinations thereof. In one embodiment, at least a portion of the metal cation is present as a salt with an anion selected from chloride, hydroxide, and carbonate.

In one embodiment, the metal cation is present in a concentration greater than about 0.4 mmol per gram of doped conductive polymer. In one embodiment, the metal cation is present in a concentration between about 0.5 and 3 mmol per gram of doped conductive polymer. In one embodiment, the metal cation is present in a concentration between about 0.6 and 2 mmol per gram of doped conductive polymer.

The new composition can be formed into a layer. The term “layer” is used interchangeably with the term “film” and refers to a coating covering a desired area. The area can be as large as an entire device or as small as a specific functional area such as the actual visual display, or as small as a single sub-pixel. Films can be formed by any conventional deposition technique. Typical liquid deposition techniques include, but are not limited to, continuous deposition techniques such as spin coating, gravure coating, curtain coating, dip coating, slot-die coating, spray coating, and continuous nozzle coating; and discontinuous deposition techniques such as ink jet printing, gravure printing, and screen printing. Layers may also be formed by thermal transfer. A donor sheet of the desired material is exposed to a thermal head or laser to transfer the material from the donor onto a desired substrate.

In one embodiment, the new compositions can be used to form buffer layers in an electronic device. The term “buffer layer” as used herein, is intended to mean an electrically conductive or semiconductive layer which can be used between an anode and an active organic material. A buffer layer is believed to accomplish one or more functions in an organic electronic device, including, but not limited to planarization of the underlying layer, hole transport, hole injection, scavenging of impurities, such as oxygen and metal ions, among other aspects to facilitate or to improve the performance of an organic electronic device.

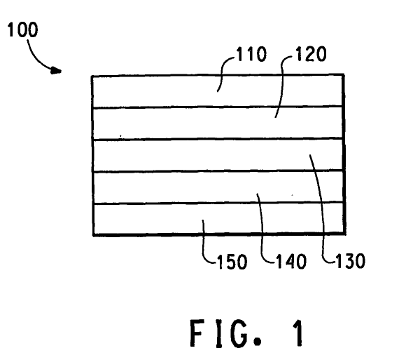

In one embodiment, the organic electronic device comprises an electroactive layer positioned between two electrical contact layers, wherein the device includes a layer made from the new composition. One embodiment is illustrated in one type of OLED device, as shown in FIG. 1, which is a device that has anode layer 110, a buffer layer 120, an electroluminescent layer 130, and a cathode layer 150. Adjacent to the cathode layer 150 is an optional electron-injection/transport layer 140. Between the buffer layer 120 and the cathode layer 150 (or optional electron injection/transport layer 140) is the electroluminescent layer 130.

The device may include a support or substrate (not shown) that can be adjacent to the anode layer 110 or the cathode layer 150. Most frequently, the support is adjacent the anode layer 110. The support can be flexible or rigid, organic or inorganic. Generally, glass or flexible organic films are used as a support. The anode layer 110 is an electrode that is more efficient for injecting holes compared to the cathode layer 150. The anode can include materials containing a metal, mixed metal, alloy, metal oxide or mixed oxide. Suitable materials include the mixed oxides of the Group 2 elements (i.e., Be, Mg, Ca, Sr, Ba, Ra), the Group 11 elements, the elements in Groups 4, 5, and 6, and the Group 8-10 transition elements. If the anode layer 110 is to be light transmitting, mixed oxides of Groups 12, 13 and 14 elements, such as indium-tin-oxide, may be used. As used herein, the phrase “mixed oxide” refers to oxides having two or more different cations selected from the Group 2 elements or the Groups 12, 13, or 14 elements. Some non-limiting, specific examples of materials for anode layer 110 include, but are not limited to, indium-tin-oxide (“ITO”), aluminum-tin-oxide, gold, silver, copper, and nickel. The anode may also comprise an organic material such as polyaniline, polythiophene, or polypyrrole.

The anode layer 110 may be formed by a chemical or physical vapor deposition process or spin-coating process. Chemical vapor deposition may be performed as a plasma-enhanced chemical vapor deposition (“PECVD”) or metal organic chemical vapor deposition (“MOCVD”). Physical vapor deposition can include all forms of sputtering, including ion beam sputtering, as well as e-beam evaporation and resistance evaporation. Specific forms of physical vapor deposition include rf magnetron sputtering and inductively-coupled plasma physical vapor deposition (“IMP-PVD”). These deposition techniques are well known within the semiconductor fabrication arts.

The anode layer 110 may be patterned during a lithographic operation. The pattern may vary as desired. The layers can be formed in a pattern by, for example, positioning a patterned mask or resist on the support prior to applying the first electrical contact layer material. Alternatively, the layers can be applied as an overall layer (also called blanket deposit) and subsequently patterned using, for example, a patterned resist layer and wet chemical or dry etching techniques. Other processes for patterning that are well known in the art can also be used. When the electronic devices are located within an array, the anode layer 110 typically is formed into substantially parallel strips having lengths that extend in substantially the same direction.

Buffer layer 120 can be formed using any deposition technique well-known to those skilled in the art, as discussed above.

The electroluminescent (“EL”) layer 130 may typically be any organic EL material, including, but not limited to, fluorescent dyes, fluorescent and phosphorescent metal complexes, conjugated polymers, and mixtures thereof. Examples of fluorescent dyes include, but are not limited to, pyrene, perylene, rubrene, derivatives thereof, and mixtures thereof. Examples of metal complexes include, but are not limited to, metal chelated oxinoid compounds, such as tris(8-hydroxyquinolato)aluminum (Alq3); cyclometalated iridium and platinum electroluminescent compounds, such as complexes of Iridium with phenylpyridine, phenylquinoline, or phenylpyrimidine ligands as disclosed in Petrov et al., Published PCT Application WO 02/02714, and organometallic complexes described in, for example, published applications US 2001/0019782, EP 1191612, WO 02/15645, and EP 1191614; and mixtures thereof. Electroluminescent emissive layers comprising a charge carrying host material and a metal complex have been described by Thompson et al., in U.S. Pat. No. 6,303,238, and by Burrows and Thompson in published PCT applications WO 00/70655 and WO 01/41512. Examples of conjugated polymers include, but are not limited to poly(phenylenevinylenes), polyfluorenes, poly(spirobifluorenes), polythiophenes, poly(p-phenylenes), copolymers thereof, and mixtures thereof. Electroluminescent polymers have been disclosed in, for example, published PCT applications WO 97/33323 and WO 98/27136, and in published German application DE 19615128. Combinations of emissive materials can be used.

The particular material chosen may depend on the specific application, potentials used during operation, or other factors. The EL layer 130 containing the electroluminescent organic material can be applied using any number of techniques including vapor deposition, solution processing techniques or thermal transfer. In another embodiment, an EL polymer precursor can be applied and then converted to the polymer, typically by heat or other source of external energy (e.g., visible light or UV radiation).

Optional layer 140 can function both to facilitate electron injection/transport, and can also serve as a confinement layer to prevent quenching reactions at layer interfaces. More specifically, layer 140 may promote electron mobility and reduce the likelihood of a quenching reaction if layers 130 and 150 would otherwise be in direct contact. Examples of materials for optional layer 140 include, but are not limited to, metal-chelated oxinoid compounds (e.g., Alq₃ or the like); phenanthroline-based compounds (e.g., 2,9-dimethyl-4,7-diphenyl-1,10-phenanthroline (“DDPA”), 4,7-diphenyl-1,10-phenanthroline (“DPA”), or the like); azole compounds (e.g., 2-(4-biphenylyl)-5-(4-t-butylphenyl)-1,3,4-oxadiazole (“PBD” or the like), 3-(4-biphenylyl)-4-phenyl-5-(4-t-butylphenyl)-1,2,4-triazole (“TAZ” or the like); other similar compounds; or any one or more combinations thereof. Alternatively, optional layer 140 may be inorganic and comprise BaO, LiF, Li₂O, or the like.

The cathode layer 150 is an electrode that is particularly efficient for injecting electrons or negative charge carriers. The cathode layer 150 can be any metal or nonmetal having a lower work function than the first electrical contact layer (in this case, the anode layer 110). As used herein, the term “lower work function” is intended to mean a material having a work function no greater than about 4.4 eV. As used herein, “higher work function” is intended to mean a material having a work function of at least approximately 4.4 eV.

Materials for the cathode layer can be selected from alkali metals of Group 1 (e.g., Li, Na, K, Rb, Cs,), the Group 2 metals (e.g., Mg, Ca, Ba, or the like), the Group 12 metals, the lanthanides (e.g., Ce, Sm, Eu, or the like), and the actinides (e.g., Th, U, or the like). Materials such as aluminum, indium, yttrium, and combinations thereof, may also be used. Specific non-limiting examples of materials for the cathode layer 150 include, but are not limited to, barium, lithium, cerium, cesium, europium, rubidium, yttrium, magnesium, samarium, and alloys and combinations thereof.

The cathode layer 150 is usually formed by a chemical or physical vapor deposition process. In general, the cathode layer will be patterned, as discussed above in reference to the anode layer 110. If the device lies within an array, the cathode layer 150 may be patterned into substantially parallel strips, where the lengths of the cathode layer strips extend in substantially the same direction and substantially perpendicular to the lengths of the anode layer strips. Electronic elements called pixels are formed at the cross points (where an anode layer strip intersects a cathode layer strip when the array is seen from a plan or top view).

In other embodiments, additional layer(s) may be present within organic electronic devices. For example, a layer (not shown) between the buffer layer 120 and the EL layer 130 may facilitate positive charge transport, band-gap matching of the layers, function as a protective layer, or the like. Similarly, additional layers (not shown) between the EL layer 130 and the cathode layer 150 may facilitate negative charge transport, band-gap matching between the layers, function as a protective layer, or the like. Layers that are known in the art can be used. In addition, any of the above-described layers can be made of two or more layers. Alternatively, some or all of inorganic anode layer 110, the buffer layer 120, the EL layer 130, and cathode layer 150, may be surface treated to increase charge carrier transport efficiency. The choice of materials for each of the component layers may be determined by balancing the goals of providing a device with high device efficiency with the cost of manufacturing, manufacturing complexities, or potentially other factors.

The different layers may have any suitable thickness. In one embodiment, inorganic anode layer 110 is usually no greater than approximately 500 nm, for example, approximately 10-200 nm; buffer layer 120, is usually no greater than approximately 250 nm. In one embodiment, the second layer is less than 10 nm. EL layer 130, is usually no greater than approximately 100 nm, for example, approximately 50-80 nm; optional layer 140 is usually no greater than approximately 100 nm, for example, approximately 20-80 nm; and cathode layer 150 is usually no greater than approximately 100 nm, for example, approximately 1-50 nm. If the anode layer 110 or the cathode layer 150 needs to transmit at least some light, the thickness of such layer may not exceed approximately 100 nm.

In organic light emitting diodes (OLEDs), electrons and holes, injected from the cathode 150 and anode 110 layers, respectively, into the EL layer 130, form negative and positively charged polar ions in the polymer. These polar ions migrate under the influence of the applied electric field, forming a polar ion exciton with an oppositely charged species and subsequently undergoing radiative recombination. A sufficient potential difference between the anode and cathode, usually less than approximately 12 volts, and in many instances no greater than approximately 5 volts, may be applied to the device. The actual potential difference may depend on the use of the device in a larger electronic component. In many embodiments, the anode layer 110 is biased to a positive voltage and the cathode layer 150 is at substantially ground potential or zero volts during the operation of the electronic device. A battery or other power source(s) may be electrically connected to the electronic device as part of a circuit but is not illustrated in FIG. 1.

It has been found in some OLED devices having an anode patterned into parallel strips, that a defect known as “wide column gap” (“WCG”) can occur. In this context, the anode strips are running in the verticl (“column”) direction on the display as normally viewed. The WCG defect occurs anywhere on the display where two adjacent anode lines are biased at “on” and “off” voltages. The defect manifests itself as an apparent growth of the dark region between the adjacent anode lines, distorting the image. The WCG defect is, to some extent, reversible and the degraded area recovers when the anodes are returned to a common voltage. Recovery of the area degraded by the WCG defect can sometimes be accelerated by inverting the image so the “on” and “off” voltages are reversed.

The term “organic electronic device” is intended to mean a device including one or more semiconductor layers or materials. Organic electronic devices include: (1) devices that convert electrical energy into radiation (e.g., a light-emitting diode, light-emitting diode display, or diode laser), (2) devices that detect signals through electronics processes (e.g., photodetectors (e.g., photoconductive cells, photoresistors, photoswitches, phototransistors, phototubes), IR detectors), (3) devices that convert radiation into electrical energy (e.g., a photovoltaic device or solar cell), and (4) devices that include one or more electronic components that [image] [image] include one or more organic semi-conductor layers (e.g., a transistor or diode).

In one embodiment, buffer layers made from the new compositions are effective at preventing WCG in OLED displays.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, use of the “a” or “an” are employed to describe elements and components of the invention. This is done merely for convenience and to give a general sense of the invention. This description should be read to include one or at least one and the singular also includes the plural unless it is obvious that it is meant otherwise.

The new compositions and their uses will now be described in greater detail by reference to the following non-limiting examples.

### EXAMPLES

Test Method

The wide column experiment was done as follows. The electrical schematic of the wide column defect experiment is given in Scheme 1, below.

[image]

[image]

Glass/ITO substrates having an ITO thickness of about 100 to 150 nm were used. The ITO was patterned into parallel lines about 370 μm wide which were spaced about 50 μm apart. The ITO line plates were then spin-coated with a photo-resist and subsequently patterned into mushroom-shaped lines perpendicular to the ITO lines. Adjacent mushroom lines were spaced 370 μm apart, therefore forming pixels having the dimension of 370 μm×370 μm. The substrates with patterned ITO and mushroom lines were cleaned and subsequently treated with UV ozone. The buffer layer was spin-coated onto the ITO/mushroom/glass substrates to a thickness of about 200 nm. The spin-coated films were then baked at 90° C. in vacuum for 30 minutes. For the light-emitting layer, a 1% (w/v) toluene solution of a polyphenylene vinylene polymer (Super Yellow from Covion, Frankfurt, Germany) was spin-coated on top of the dried buffer layer and subsequently baked at 130° C. in nitrogen for 30 minutes, with a final thickness of about 70 nm. Immediately after, a 3.0 nm thick barium layer and 350 nm thick aluminum layer were deposited on the emitter layer to serve as a cathode. The mushroom lines were there to prevent cathodes from joining together. A glass cover was placed over the device to protect it from oxygen and moisture. A forward bias of 3.5 volts was applied across all the device cathodes and anodes, and a photograph was taken. This was the “base photograph”. The forward bias across the device was then turned off and +14 Volts DC (Direct Current) electrical bias was applied to the first anode column visible in the base photograph, while the second anode column, adjacent to the first anode column and also visible in the base photograph, was connected to the electrical ground. The remainder of the cathodes and anodes were left electrically floating. The electrical bias between the two anode columns was kept on for 64 hours and the electrical current between the 2 columns was recorded at the start and at the finish of applying the bias. The electrical bias between the two anode columns was then removed and immediately after, a forward bias of 3.5 volts was applied across all the device cathodes and anodes. At this point, the “final photograph” was taken. The base and final photographs were visually compared to determine the magnitude of the “wide column defect”. The defect was evaluated and give a “WCG Severity Rating” on a scale of 0 to 5, where 0 indicated no defect and 5 indicated a severe defect.

### Comparative Example 1

In this Comparative Example, Baytron-P® CH8000 as received, was used as the buffer layer. The CH8000 dispersion has a pH of about 1.6 and contains 0.4 mmoles sodium ion per gram of dried polymer. It has a sulfate content less than 10 ppm. Devices were fabricated and tested as described above. The effect of applying reverse bias is shown in Table 1. It can be seen that a device having a buffer layer made from as-received Baytron-P® CH8000 with a sodium level of 0.4 mmoles per gram of dried polymer shows a serious wide column defect problem.

TABLE 1
Effect of reverse bias current on formation of wide
column defect from as-received Baytron-P ®.

| | Current between 2 | Current between 2 | WCG |
|---|---|---|---|
| | anode columns at | anode columns at | Severity |
| Buffer | start, μA | finish, μA | Rating |
| Baytron-P ® | 6 | 2 | 5 |
| CH8000 | | | |

### Comparative Example 2

This comparative example demonstrates the effect of the pH of Baytron-P® Al4083 (Lot# CHDSPS0006; solid: 1.48%, pH=1.8) on device performance.

80 g Al4083 was added with 4 g each of Lewatit S100 and MP 62 WS for 20 minutes. Lewatit® S100, a trade name from Bayer, Pittsburgh, Pa., for sodium sulfonate of crosslinked polystyrene, and 7.70 g Lewatit® MP62 WS, a trade from Bayer, Pittsburgh, Pa., for free base/chloride of tertiary/quaternary amine of crosslinked polystyrene. The two resins were washed first before use with deionized water separately until there was no color in the water. The resins were removed by filtration through VWR #417 filter paper (40 μm). The pH was measured to be 2.2 and was adjusted to 3.95 by the addition of 1.0M NaOH aqueous solution. Half of the sample is designated as comp. 2a (see Table 2). The other half was further adjusted with the 1.0M NaOH solution to pH of 7. This sample is designated as comp. 2b.

Comp. 2a and 2b and Al4083 were then tested for device performance. Each was spun on glass/ITO backlight substrates (30 mm×30 mm) and baked at 200° C. in air for 3 minutes. The substrate had an ITO thickness of 100 to 150 nm and an ITO area of 15 mm×20 mm for light emission. The thickness of the buffer layer is given in Table 5 below. For the light-emitting layer, a 1% (w/v) toluene solution of Lumination Green from Dow Chemicals (Midland, Mich.) was spin-coated on top of the buffer layer films and subsequently baked at 100° C. in vacuum for 30 minutes. The final thickness was 740 Å. Immediately after, a 3 nm thick barium layer and a 300-500 nm aluminum layer were deposited on the Lumination Green films to serve as a cathode. The device data summarized in Table 2 clearly shows that Baytron-P® Al4083 has a much higher voltage and much lower efficiency when the pH is increased from 1.8 to 4 or 7. This result clearly shows that Baytron-P® starts to lose effectiveness as a buffer layer when adjusted to a pH greater than ˜2.

TABLE 2
Device Performance at 1,000 cd/m2 and 25° C.

| | Buffer | | |
|---|---|---|---|
| | 4083 | Comp. 2a | Comp. 2b |
| | (pH: 1.8) | (pH = 4) | (pH = 7) |
| Efficiency (cd/A) | 3.8 | 0.2 | 0.1 |
| Voltage (V) | 3.7 | 4.5 | 4.6 |
| Buffer Thickness (Å) | 815 | 932 | 855 |

### Comparative Example 3

This example illustrates the effect of voltage, operating time, and deionization of the hole injection material on WCG defect formation.

Devices were fabricated and tested as described in the test procedure above. The buffer layer was either as-received Baytron-P® CH8000, or deionized Baytron-P® CH8000.

TABLE 3
Test results.

| | Approx. Cation | | |
|---|---|---|---|
| | Concentration | | WCG Severity |
| Buffer Solution | [mmol/g of dried | | Ranking |
| Composition | polymer] | Test Conditions | (5 = worst) |
| PEDOT as | 0.4 Na+ | 14 V for 30 min. | 4 |
| received | | | |
| PEDOT as | 0.4 Na+ | 14 V for 60 min. | 4 |
| received | | | |
| PEDOT as | 0.4 Na+ | 20 V for 20 min. | 4 |
| received | | | |
| PEDOT as | 0.4 Na+ | 20 V for 120 min. | 4 |
| received | | | |
| deionized | <0.001 Na+ | 14 V for 60 min. | 5 |
| PEDOT | | | |

The results suggest that the defect was not sensitive to the applied voltage or the duration of operation. However, the defect seemed sensitive to ion concentration in the buffer layer, as indicated by the fact that the defect was more severe when deionized PEDOT dispersion was used, where sodium was mostly removed.

### Example 1

This example illustrates the effect of additive concentration and metal cation type on the WCG defect. Devices were fabricated and tested as described in the above Test Method. The buffer layers were made from Baytron-P® CH8000 with different amounts of added cations, as indicated in Table 4 below.

TABLE 4

| | Approx. Metal | | |
|---|---|---|---|
| | Cation Conc. | | WCG Severity |
| Buffer | [mmol/g of dried | | Ranking |
| Composition | polymer] | Test Conditions | (5 = worst) |
| PEDOT as | 0.4 Na⁺ | 14 V for 30 min. | 4 |
| received | | | |
| Modified PEDOT | 0.4 Na⁺ + 0.6 K⁺ | 14 V for 30 min. | 2 |
| | (from KCl) | | |
| Modified PEDOT | 0.4 Na⁺ + 0.6 | 14 V for 30 min. | 2 |
| | Mg⁺² (from | | |
| | MgSO₄) | | |
| Modified PEDOT | 0.4 Na⁺ + 0.6 | 14 V for 30 min. | 2 |
| | Cs⁺ (from | | |
| | Cs₂CO₃) | | |
| Modified PEDOT | 0.7 Na⁺ (0.3 | 14 V for 30 min. | 2 |
| | from NaCl) | | |

The results suggest that increased metal cation concentration in the buffer layer results in a device more resistant to WCG defect. For example, the severity ranking of the defect dropped from 4 to 2 when the additive concentration was increased from 0.4 to 1.0 mmol/g. The type of additive used (i.e., whether it is K⁺, Mg²⁺, or Cs⁺) does not seem to affect the result significantly. Furthermore, the data indicates that increasing the sodium ion concentration from 0.4 to 0.7 mmol/g (using NaCl as the source) was about equally effective as adding a different type of ion to the PEDOT dispersion in terms of decreasing the severity of the defect.

### Example 2

This example illustrates the effect of co-solvents and metal cation concentration on the WCG defect.

Devices were fabricated and tested as described in the Test Method, above. For the buffer layers, certain samples used only co-solvents, certain samples used both co-solvents and metal cation additives, and certain samples used only metal cation additives. In the samples that involved co-solvents, the co-solvents were removed completely by air-drying on a hot plate at about 200° C. for approximately 3 minutes and then under vacuum at about 80° C. for approximately 5 minutes. The PEDOT used was Baytron-P® CH8000. The co-solvents used were normal propyl alcohol (nPA) and 1-methoxy-2-propanol (1M2P) in an amount so that the cosolvents in the coating composition were 10% nPA and 15% 1M2P by liquid volume.

A generally higher voltage was applied to these samples than in Example 1 to increase the general severity of the defect. Hence, the ratings in this table can not be compared with the ratings in other tables tested at a different voltage.

The results are summarized in Table 5.

TABLE 5

| | Approx. Metal | | WCG |
|---|---|---|---|
| | Cation Conc. | | Severity |
| Buffer | [mmol/g of dried | | Ranking |
| Composition | polymer] | Test Conditions | (5 = worst) |
| PEDOT as | 0.4 Na+ | 20 V for 20 min. | 4 |
| received | | | |
| PEDOT + co- | 0.4 Na⁺ | 20 V for 60 min. | 3 |
| solvents | | | |
| modified PEDOT + | 0.8 Na⁺ (0.4 | 20 V for 60 min. | 1 |
| co-solvents | from NaOH) | | |
| modified PEDOT + | 0.8 Na⁺ (0.4 | 20 V for 60 min. | 1 |
| co-solvents | from Na₂CO₃) | | |
| modified PEDOT + | 1.2 Na⁺ (0.8 | 20 V for 60 min. | 1 |
| co-solvents | from NaOH) | | |
| modified PEDOT + | 0.8 Na⁺ (0.4 | 20 V for 60 min. | 0 |
| co-solvents | from NaCl) | | |
| modified PEDOT | 2.0 Na⁺ (1.6 | 20 V for 120 min. | 0 |
| | from NaOH) | | |
| Mofidified | 3.0 Na⁺ (2.6 | 20 V for 120 min. | 0 |
| PEDOT | from NaOH) | | |

For larger coating areas, for example, larger than 370×470 mm, the coating homogeneity and film quality were significantly better for the samples containing co-solvent.

The data also suggests that NaCl may be a more effective additive than NaOH or Na₂CO₃, at least with the exact parameters used for the samples in this Example. While 0.8 mmol/g of Na⁺ from NaOH or Na₂CO₃ lowered the severity ranking to 1, the same concentration of Na⁺ that was achieved from NaCl completely eliminated the defect.

The last two runs in this Example indicate the general levels of salt that eliminate WCG defect in the absence of co-solvents. Since device performance begins to deteriorate when sodium ion concentration is about 3 mmol/g, the sodium ion levels in these runs are at the high end of what is considered to be an acceptable salt level. It should be noted here that pH of the PEDOT modified with sodium hydroxide having 3 mmoles sodium per gram polymer is still below 2.

### Example 3

This example tests the limit of the operating conditions that can be handled by salt and co-solvent(s) in terms of WCG resistance. Devices were fabricated and tested as in the Test Method, above.

TABLE 6

| | Approx. Metal | | |
|---|---|---|---|
| | Cation Conc. | | Severity |
| Buffer | [mmol/g of dried | | Ranking |
| Composition | polymer] | Test Conditions | (5 = worst) |
| modified PEDOT | 2.0 Na⁺ (1.6 | 30 V for 5 hrs. | 1 |
| | from NaOH) | | |
| modified PEDOT + | 2.0 Na⁺ (1.6 | 30 V for 5 hrs. | 1 |
| co-solvents | from NaOH) | | |
| modified PEDOT | 3.0 Na⁺ (2.6 | 30 V for 14 hrs. | 1 |
| | from NaOH) | | |
| modified PEDOT + | 3.0 Na⁺ (2.6 | 30 V for 14 hrs. | 1 |
| co-solvents | from Na₂CO₃) | | |

For larger coating areas, for example, larger than 370×470 mm, the coating homogeneity and film quality were significantly better for the samples containing co-solvent.

After applying 30 V potential difference for several hours, all the samples showed a relatively small degree of WCG defect. Even at the maximum acceptable level of sodium ion concentration (3.0 mmol/g), the WCG defect could not be completely eliminated. This was true regardless of whether co-solvents were used, indicating that if operation conditions are made harsh enough, WCG defect formation may not be completely preventable with salt and co-solvents.

### Example 4

This example illustrates the effect of metal cation additives and co-solvents on recovery.

Devices were fabricated and tested as in the Test Method, above. The buffer layer was PEDOT with the additive concentrations shown in Table 7. To better simulate the actual impact of metal cations and co-solvents on a display device, the compositions shown in Table 7 were made into display devices and driven with a Soloman 1301 driver. In this example, the adjacent anode columns were held at a voltage difference of about 12.3 V, and the row (cathode) voltages were scanned at a rate of 80 Hz. The “on” voltages were adjusted to achieve a brightness level of about 200 cd/m². (This did not affect the voltage difference across the anode column lines). The displays were tested in this mode for 82 hours and the severity of the defect was noted as shown below. The display devices were tested for an additional period of time for a total of 101 hours of operation. No further increase in the severity of the WCG defect occurred between the 82-hour point and the 101-hour point.

After 101 hours of operation, the displays were turned off and allowed to recover for about 16 hours. Then, they were lit briefly to be inspected for the extent of recovery.

TABLE 7

| | | | Severity |
|---|---|---|---|
| | Approx. Metal | WCG | Ranking |
| | Cation Conc. | Severity | after 16 hr. |
| Buffer | [mmol/g of dried | Ranking | recovery |
| Composition | polymer] | (5 = worst) | (5 = worst) |
| PEDOT as | 0.4 Na⁺ | 5 | 5 |
| received | | | |
| PEDOT + co- | 0.4 Na⁺ | 4 | 4 |
| solvents | | | |
| modified PEDOT + | 0.8 Na⁺ (0.4 | 3 | 1 |
| co-solvents | from NaOH) | | |
| modified PEDOT + | 0.8 Na⁺ + (0.4 | 3 | 1 |
| co-solvents | from Na₂CO₃) | | |
| modified PEDOT + | 0.8 Na⁺ (0.4 | 3 | 3 |
| co-solvents | from NaCl) | | |
| modified PEDOT + | 1.2 Na⁺ (0.8 | 2 | 1 |
| co-solvents | from Na₂CO₃) | | |

The data suggests that metal additives might play an important role in recovering from defect. The first sample, which included no additional metal additives and no co-solvents, showed almost no recovery in the 16-hour period. The second sample, which included co-solvents but no extra metal additives, suffered less defect to begin with but showed no recovery during the 16-hour period.

Among the three runs that included co-solvents and sodium ions at about 0.8 mmol/g, only the sample that used NaCl as the ion source showed no recovery. When combined with observations about NaCl made above in Example 2, the data indicates that NaCl may be preferable for defect prevention, at least at an operating condition of about 20 V and 60 minutes; however, NaCl may not be preferable for harsher operating conditions because it does not lead to the best recovery. Example 3 suggests that there is a limit to the harshness of operating condition at which salts and co-solvents can prevent WCG defect formation. Thus, if the operating condition will be above that limit, it may be preferable to use Na₂CO₃ and NaOH as dopant sources because they showed better recovery in Example 4.

While the invention has been described in detail with reference to certain preferred embodiments thereof, it will be understood that modifications and variations are within the spirit and scope of that which is described and claimed.

What is claimed is:

1. An aqueous composition comprising at least one doped conductive polymer, at least one co-solvent, and at least one metal cation selected from Group 1 metals, Group 2 metals, or mixtures thereof.

2. A composition according to claim 1, wherein the conductive polymer is selected from polythiophenes, polypyrroles, polyanilines, or combinations thereof.

3. A composition according to claim 2, wherein the polythiophene comprises Formula I: 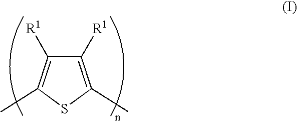
wherein:
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms, and
n is at least about 4.

4. A composition according to claim 2, wherein the polypyrrole comprises Formula II: 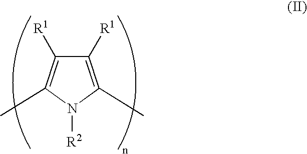
wherein:
n is at least about 4;
R¹ is independently selected so as to be the same or different at each occurrence and is selected from hydrogen, alkyl, alkenyl, alkoxy, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, acrylic acid, phosphoric acid, phosphonic acid, halogen, nitro, cyano, hydroxyl, epoxy, silane, siloxane, alcohol, benzyl, carboxylate, ether, ether carboxylate, ether sulfonate, and urethane; or both R¹ groups together may form an alkylene or alkenylene chain completing a 3, 4, 5, 6, or 7-membered aromatic or alicyclic ring, which ring may optionally include one or more divalent nitrogen, sulfur or oxygen atoms; and
R² is independently selected so as to be the same or different at each occurrence and is selected from hydrogen, alkyl, alkenyl, aryl, alkanoyl, alkylthioalkyl, alkylaryl, arylalkyl, amino, epoxy, silane, siloxane, alcohol, benzyl, carboxylate, ether, ether carboxylate, ether sulfonate, and urethane.

5. A composition according to claim 2, wherein the polyaniline comprises Formula III or Formula IV: 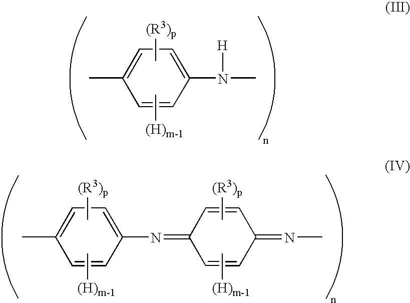
wherein:
n is at least about 4;
p is an integer from 0 to 4;
m is an integer from 1 to 5, with the proviso that p+m=5; and
R³ is independently selected so as to be the same or different at each occurrence and is selected from alkyl, alkenyl, alkoxy, cycloalkyl, cycloalkenyl, alkanoyl, alkythio, aryloxy, alkylthioalkyl, alkylaryl, arylalkyl, amino, alkylamino, dialkylamino, aryl, alkylsulfinyl, alkoxyalkyl, alkylsulfonyl, arylthio, arylsulfinyl, alkoxycarbonyl, arylsulfonyl, carboxylic acid, halogen, cyano, or alkyl substituted with one or more of sulfonic acid, carboxylic acid, halo, nitro, cyano or epoxy moieties; or any two R³ groups together may form an alkylene or alkenylene chain completing a 3, 4, 5, 6, or 7-membered aromatic or alicyclic ring, which ring may optionally include one or more divalent nitrogen, sulfur or oxygen atoms.

6. A composition according to claim 1, wherein the conductive polymer comprises poly(3,4-ethylenedioxythiophene).

7. A composition according to claim 1, wherein the co-solvent is selected from ethers, cyclic ethers, alcohols, alcohol ethers, ketones, nitriles, sulfides, sulfoxides, amides, amines, carboxylic acids, or combinations thereof.

8. A composition according to claim 1, wherein the co-solvent is selected from an alcohol, an alcohol ether, or combinations thereof.

9. A composition according to claim 8, wherein the co-solvent is selected from normal propyl alcohol, 1-methoxy-2-propanol, or combinations thereof.

10. A composition according to claim 1, wherein the co-solvent is present in an amount from about 5% to about 60% by weight based on the total weight of liquid.

11. A composition according to claim 1, wherein the co-solvent is present in an amount from about 10% to about 30% by weight based on the total weight of liquid.

12. A composition according to claim 1, wherein the metal cation is selected from Na⁺, K⁺, Cs⁺ Mg⁺², or combinations thereof.

13. A composition according to claim 12, wherein at least a portion of the metal cation is present as a salt with an anion selected from hydroxide, or carbonate.

14. A composition according to claim 1, wherein the metal cation is present in a concentration greater than about 0.4 mmol per gram of doped conductive polymer.

15. A composition according to claim 1, wherein the metal cation is present in a concentration between about 0.5 and 3 mmol per gram of doped conductive polymer.

16. A composition according to claim 1, wherein the metal cation is present in a concentration between about 0.6 and 2 mmol per gram of doped conductive polymer.

17. A buffer layer made from a composition according to claim 1.

18. An electronic device comprising a buffer layer made from a composition according to claim 1.

19. A device of claim 18, wherein the device is selected from a device that converts electrical energy into radiation, a device that detects signals through electronics processes, devices that convert radiation into electrical energy, or a device that includes at least one semi-conductor layer.
